(19) United States
(12) Patent Application Publication
(10) Pub. No.: US 2011/0146126 A1
(43) Pub. Date: Jun. 23, 2011

(54) DEVICE FOR AND METHOD OF HOLDING AND DISPLAYING SHEET ARTICLES

(76) Inventor: Charles PHILLIPS, White Plains, NY (US)

(21) Appl. No.: 12/644,606

(22) Filed: Dec. 22, 2009

(51) Int. Cl. A47G 1/06; B29C 53/04

(52) U.S. Cl. 40/738; 156/212; 40/773

(57) ABSTRACT

A display device includes a foam panel resiliently bendable from a generally planar configuration to an arcuate configuration, a sheet article, such as a picture, including a base sheet bearing an image to be displayed, and an adhesive carrier for adhering the base sheet in surface area contact with the foam panel. The base sheet is non-stretchable to hold and maintain the foam panel in the arcuate configuration, thereby enabling viewing of the image in curved form. A frame of a resilient foam material may peripherally surround the foam panel in the generally planar configuration with an interchangeable, compression fit. The foam panel self-conforms to any irregularities on a support surface against which the foam panel is directly mounted.

### DESCRIPTION OF THE RELATED ART

The present invention relates to a device for and a method of holding and displaying sheet articles, such as photographs, certificates, greeting cards, artwork, pictures, documents and the like.

Traditional formal framing of sheet articles, such as photographs, pictures, and like printed art, usually involves mounting and supporting the article flat in a rigid frame having a rear brace for mounting the frame on a horizontal support surface, such as a tabletop, or having a wire attached to the back of the frame for hanging the frame on a hook or nail-like protrusion extending from a vertical wall. Unframed and unsupported art printed on paper and like pulp substrates tends to curl as the substrates absorb and lose moisture periodically over time. The effort and expense of traditional framing prevents its widespread adoption to display informal candid photographs of people, pets, or scenery and the like taken during parties, vacations, or everyday occurrences. Many such informal photographs are mounted flat against, and displayed on, a refrigerator door, filing cabinet or locker using magnets or adhesive tape. Such display methods are not only unattractive and lead to curling of the sheet article, but also do not protect the article, often resulting in torn edges, or damage to the face, of the sheet article.

Other types of inexpensive framing techniques involve putting the article flat beneath a glass protector on a table or a desk, or a clear cover sheet of a desk blotter, or directly securing the article flat against a wall or corkboard mounting surface using static cling film, tacks or tape. While inexpensive, tape or static cling film are disadvantageous in that either can lose its holding properties over time. When an adhesive is used, the adhesive may either leave a residue on, or mar, the mounting surface once the article is removed. Tacks leave holes in the mounting surface. Static cling film can be difficult to work with in that it can bunch up and stick to itself, thereby making mounting difficult.

It is also known to mount photographic prints on stiff, laminated foam boards consisting of an inner layer of polystyrene foam and a pair of outer cladding layers made of a pulp-based, white claycoated paper or brown Kraft paper. Such stiff foam boards, however, are relatively easily bruised, warp and often have unfinished or deformed, crushed edges. Such stiff foam boards are also prone to creasing and curling as the pulp-based cladding layers absorb and lose moisture periodically over time. Such bruising and creasing are aggravated during shipment of such stiff foam boards to a retailer. Also, hot glues applied between the prints and the foam boards can affect finished projects in the form of board warping, bubbles, or other unsightly blemishes. Self-adhesive foam boards, intended for art and document mounting, are also available. However, such self-adhesive foam boards can be very tricky to use properly, because the adhesive sets very quickly.

In an effort to reduce the curling caused by the long-term use of pulp-based materials, it is also known to mount photographic prints on plastic backing boards. However, such plastic boards are rigid and are not able to readily conform to non-planar irregularities commonly found on many walls when it is desired to directly wall mount such plastic boards. Often, resort is made to using double-sided foam tape to compensate for such wall irregularities.

Thus, conventional framing techniques basically allow a two-dimensional article to be flatly displayed in a plane. It would be desirable to add a three-dimensional effect to a picture to be displayed. The art has suggested mounting photographs in three-dimensional, curved, rigid frames. However, such rigid frames are bulky and expensive to ship and waste cargo space. Moreover, such rigid frames are not adjustable and, hence, any three-dimensional effect achieved by such rigid frames is not adjustable.

Accordingly, there is a need for an easy-to-use, inexpensive, moisture-resistant, durable device for holding and displaying sheet articles, especially informal articles for which traditional formal framing in rigid frames is not desired, and for imparting an adjustable, three-dimensional effect that adds depth in the mind of a viewer to the article being displayed, all without marring a mounting surface for supporting the device, while preserving its holding property, while readily conforming to wall irregularities, and while resisting curling due to moisture over long-term usage.

### SUMMARY OF THE INVENTION

One feature of this invention resides, briefly stated, in a display device, which includes a foam panel resiliently bendable from a generally planar configuration to an arcuate configuration, and a sheet article including a base sheet bearing an image to be displayed, and adhered in surface area contact to the foam panel. The base sheet is non-stretchable to hold and maintain the foam panel in the arcuate configuration, thereby enabling viewing of the image in curved form and imparting a three-dimensional effect that adds depth in the mind of a viewer to the image being displayed. The foam panel may be bent more than once, and may be bent to any desired curvature, thereby adjusting the three-dimensional effect. Thus, if bent into an arc, then the foam panel may be adjustably bent to any desired radius of curvature.

The foam panel has a thickness dimension on the order of from 2 mm to 10 mm, preferably 6 mm, and is entirely constituted of a resilient, non-laminated, foam material, such as ethylene vinyl acetate (EVA). The foam material is preferably a closed-cell, water-resistant material to resist any absorption and loss of moisture typically encountered in the known art due to seasonal environmental changes. The resilient foam panel is flexible and bends in all directions, and usually self-returns back towards its normal generally planar configuration due to its inherent resilience. By adhering the non-stretchable base sheet to, and in surface area contact with, one side of the foam panel, however, the resilient property of the resilient foam panel is modified, because the base sheet acts to resist the foam panel from returning to its generally planar configuration and maintains the bent foam panel in the arcuate configuration. The foam panel advantageously, but not necessarily, has length and width dimensions that match those of the sheet article.

The base sheet is adhered to the foam panel by a planar adhesive carrier that comprises a central film having its side facing the foam panel coated with a permanent, pressure-sensitive adhesive, such as a rubber- or acrylic-based adhesive, and its opposite side facing the base sheet coated with a repositionable, pressure-sensitive adhesive that allows multiple opportunities and time, for example, one hour, to accurately position the base sheet on the foam panel. Advantageously, the adhesive carrier is pre-applied to the foam panel, and a removable release liner covers the repositionable adhesive. The release liner is removed just before the base sheet is adhered thereto.

The thickness dimension of the foam panel forms a generally planar bottom edge sufficient, together with its arcuate configuration, for self-supporting the display device and holding the sheet article generally upright on a generally planar support surface, such as a tabletop, shelf, or desktop. The thickness dimension of the foam panel also adds heft and dimension to the sheet article itself. A flexible support or stand could be pre-attached on the foam panel, or can be attached when needed after the bending operation, for more stably supporting the sheet article upright on the generally planar support surface, or for orienting the sheet article at a desired tilt angle relative to the generally planar support surface, or for suspending the sheet article. Advantageously, the support is an elongated strip having a pair of semi-rigid, deformable wires embedded therein. The strip extends along one of the dimensions of the foam panel and past the same. The wires are deformed at the region where the strip extends past the foam panel to form a support base that overlies the support surface and supports the sheet article thereon, or to form a suspension hook. A pressure-sensitive adhesive is coated on and along the support and faces the foam panel to hold the support against the foam panel. Advantageously, a removable release liner covers the adhesive on the support. The release liner is removed just before the support is adhered to the foam panel. If the liner is removed from the region where the strip extends past the foam panel, then the adhesive can be used to adhere the support to the support surface. If the support holds or suspends the foam panel out of contact with the support surface, then it appears as if the sheet article is floating.

Thus, the sheet article, such as photographs, certificates, greeting cards, artwork, pictures, documents and the like, especially informal articles for which traditional formal framing in rigid frames is not desired, is imparted an adjustable three-dimensional effect to add depth in the mind of a viewer to the image being displayed. Bending of the foam panel is preferably performed as many times as desired by a consumer. The foam panel may be initially placed in its planar configuration, with the attached sheet article, directly in an envelope and shipped to the consumer compactly without damage. Thus, the display device is self-protective during shipping.

Another feature of this invention resides, briefly stated, in a display device, which includes a resilient foam panel lying in a generally planar configuration, and a resilient frame consisting of a foam material and peripherally surrounding the foam panel with a compression fit. The foam frame bounds an opening sized slightly smaller than the size of the foam panel to insure a snug, tight, resiliently elastic engagement between the foam panel and the frame. The foam frame and the foam panel may have any shape, but each is preferably rectangular. The foam frame may be formed as a single die-cut piece, or as a plurality of pieces, e.g., four pieces arranged as sides of a rectangle. Advantageously, a sheet article includes a base sheet bearing an image to be displayed, and is adhered in surface area contact to the foam panel. The foam panel advantageously, but not necessarily, has length and width dimensions that match those of the sheet article. An optional light-transmissive cover advantageously overlies the foam panel and is surrounded by the frame. The foam frame and foam panel are an attractive assembly, well suited for mounting in a nursery where hard, rigid framing structures are to be avoided in the interest of child safety. The foam frame is interchangeable with other foam frames.

Repositionable, pressure-sensitive adhesive carriers, such as one or more strips, are provided on the foam panel and/or the frame for repositionably adhering the foam panel and/or the frame directly to a generally upright support surface, such as a wall, or to a backing board that is supported on a horizontal support surface. The strips occupy less than the entire surface area of the foam panel and/or the frame, thereby aiding in removal of the display device from the wall or backing board, and also allowing for use of a stronger repositionable adhesive than in full coverage. Each strip is preferably linear and has peripheral edges parallel to a peripheral edge of the foam panel. If two strips are employed, then they are preferably parallel to each other. Each adhesive carrier comprises a central substrate having its side facing the foam panel coated with a permanent, pressure-sensitive adhesive, such as a rubber- or acrylic-based adhesive, and its opposite side facing the wall or backing board coated with a repositionable, pressure-sensitive adhesive that allows multiple opportunities and time, for example, one hour, to accurately position the foam panel and/or the frame on the wall or backing board. Advantageously, a removable release liner covers the repositionable adhesive. The release liner is removed just before the foam panel and/or the frame is adhered to the wall or backing board. The resilience and flexibility of the foam panel and foam frame readily enable them to self-conform to, and self-compensate for, any non-planar irregularities commonly encountered on the wall or backing board. Double-sided foam tape is not needed, as in the prior art, for such direct wall mounting.

Still another feature of this invention resides, briefly stated, in a display method performed by bending a resilient foam panel from a generally planar configuration to an arcuate configuration, preferably by a consumer, and holding and maintaining the foam panel in the arcuate configuration by adhering a non-stretchable base sheet of a sheet article bearing an image to be displayed, in surface area contact to the foam panel, thereby enabling viewing of the image in curved form. The adhering may be performed by the consumer in advance of the bending. The bending of the foam panel may be performed more than once, and to any desired curvature, thereby adjusting the three-dimensional effect that adds image depth. Thus, if bent into an arc, then the foam panel may be adjustably bent to any desired radius of curvature.

One or more of the resilient foam panels in various sizes and shapes can be provided in craft kit form. The kit may also advantageously include one or more of the foam frames in various sizes and shapes, as well as one or more of the aforementioned supports and covers. Adhesive carriers may be provided in advance on a rear surface of each foam panel, or adhesive carriers may be provided for subsequent attachment by the consumer. Preferably, a front surface of each foam panel is covered in advance with the adhesive carrier, but it is also contemplated that the consumer may wish to subsequently coat the front surface of each foam panel with a supplied adhesive. The sheet article may be mounted in advance on the foam panel by a retailer, or subsequently by the consumer. A frame surrounding a mounted foam panel is easily removed therefrom and interchanged with another frame from the kit.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a sheet article being mounted on a foam panel in a generally planar configuration to form a display device in accordance with one embodiment of the present invention;

FIG. 2 is a perspective view of the display device of FIG. 1 self-supported on a generally horizontal support surface after the foam panel has been bent to a curved configuration;

FIG. 3 is a sectional view taken on line 3-3 of FIG. 2;

FIG. 4 is a sectional view analogous to FIG. 3, but showing another embodiment for supporting the display device on the support surface;

FIG. 5 is a front elevational view of another embodiment of a display device in accordance with the present invention, in which the foam panel in its generally planar configuration is framed;

FIG. 6 is a sectional view taken on line 6-6 of FIG. 5;

FIG. 7 is a view analogous to FIG. 6, but of a further embodiment of a display device mounted on a generally horizontal support surface in accordance with the present invention; and

FIG. 8 is a view analogous to FIG. 7, but of yet another embodiment of a display device mounted on a generally horizontal support surface in accordance with the present invention.

### DETAILED DESCRIPTION OF THE PREFERRED EMBODIMENTS

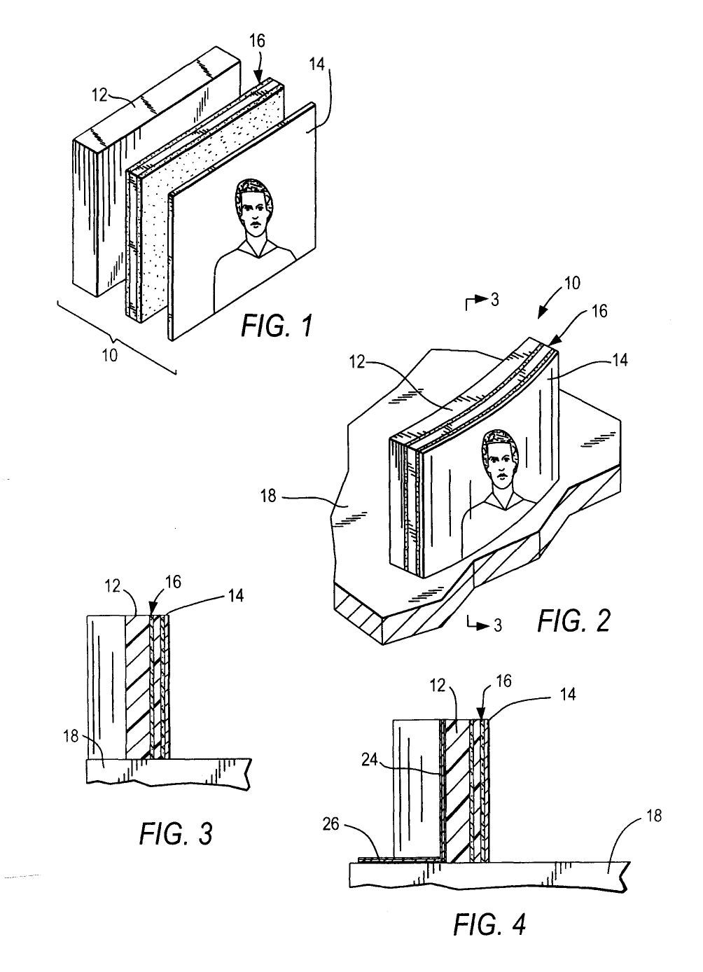

Reference numeral 10 in FIG. 1 generally identifies a display device, which includes a foam panel 12 resiliently bendable from a generally planar or flat configuration (see FIG. 1) to an arcuate or curved configuration (see FIG. 2), and a sheet article 14 including a base sheet bearing an image to be displayed, and adhered in surface area contact with the foam panel 12. Advantageously, a planar adhesive carrier 16 is used for adhering the base sheet over its entire surface area with the foam panel 12. The image may be any image, such as of any person, place or thing, and is borne on a front surface of the base sheet. The adhesive carrier 16 comprises a central substrate or film having its side facing the foam panel 12 coated with a permanent, pressure-sensitive adhesive, such as a rubber- or acrylic-based adhesive, and its opposite side facing the base sheet of the sheet article 14 coated with a repositionable, pressure-sensitive adhesive that allows multiple opportunities and time, for example, one hour, to accurately position the base sheet on the foam panel 12. Advantageously, the adhesive carrier 16 is pre-applied to the foam panel 12, and a removable release liner covers the repositionable adhesive. The release liner is removed just before the base sheet is adhered thereto.

The base sheet is non-stretchable to hold and maintain the foam panel 12 in the arcuate configuration, thereby enabling viewing of the image in curved form and imparting a three-dimensional effect that adds depth in the mind of a viewer to the image being displayed. As shown, the arcuate, convex configuration has a reversed C-shape, but other curved or non-flattened shapes are contemplated by this invention. The foam panel 12 may be bent more than once, and may be bent to any desired curvature. A plurality of foam panels 12 may be stacked on top of one another. Thus, if bent into an arc, then the foam panel 12 may be adjustably bent to any desired radius of curvature and held in that adjusted configuration by the non-stretchable base sheet.

The foam panel 12 has a thickness dimension on the order of from 2 mm to 10 mm, preferably 6 mm, and is entirely constituted of a resilient, non-laminated, foam material, such as ethylene vinyl acetate (EVA). Other foam materials are contemplated. The foam material is preferably a closed-cell, water-resistant material to resist the absorption and loss of moisture encountered in the art due to seasonal environmental changes. The resilient foam panel 12 is flexible and bends in all directions, and usually self-returns back towards its normal generally planar configuration due to its inherent resilience. By adhering the non-stretchable base sheet in surface area contact to one side of the foam panel 12, however, the resilient property of the resilient foam panel 12 is modified, because the base sheet acts to resist the foam panel 12 from returning to its generally planar configuration and maintains the bent foam panel 12 in the arcuate configuration. The foam panel 12 has length and width dimensions that preferably, but not necessarily, match those of the sheet article 14.

The thickness dimension of the foam panel 12 forms a generally planar bottom edge sufficient, together with its arcuate configuration, for self-supporting the sheet article 14 generally upright, as best shown in FIGS. 2-3, on a generally planar support surface 18, such as a tabletop, shelf, or desktop. The thickness dimension of the foam panel 12 also adds heft and dimension to the sheet article 14 itself. A flexible stand or support 24, as shown in FIG. 4, could be pre-attached on the foam panel 12, or can be attached when needed, for more stably supporting the sheet article 14 upright on the generally planar support surface 18, or for orienting the sheet article 14 at a desired tilt angle relative to the generally planar support surface 18, or for suspending the sheet article 14 from the side or from above. Advantageously, the support 24 is an elongated strip having one or more semi-rigid, deformable wires embedded therein. The support 24 extends along one of the dimensions of the foam panel 12 and past the same. The wires are deformed or bent at the region where the support 24 extends past the foam panel 12 to form a support base 26 that overlies the support surface 18 and supports the sheet article 14 thereon, or to form a suspension hook.

A pressure-sensitive adhesive is coated on and along the support 24 and faces the foam panel 12 to hold the support 24 against the foam panel 12. Advantageously, a removable release liner covers the adhesive on the support 24. The release liner is removed just before the support 24 is adhered to the foam panel 12. If the liner is removed from the region where the support 24 extends past the foam panel 12, then the adhesive can be used to adhere the support 24 to the support surface 18. If the support 24 holds or suspends the foam panel 12 out of contact with the support surface 18, then it appears as if the sheet article 14 is floating.

Thus, the sheet article 14, such as photographs, certificates, greeting cards, artwork, pictures, documents and the like, especially informal articles for which traditional formal framing in rigid frames is not desired, is imparted an adjustable three-dimensional effect that adds depth in the mind of a viewer to the image being displayed. Bending of the foam panel 12 is preferably performed by a consumer as many times and to the extent as desired. The foam panel 12 may be initially placed in its planar configuration, with the attached sheet article 14, in an envelope and shipped compactly directly to the consumer without damage. Thus, the display device is self-protective during shipping.

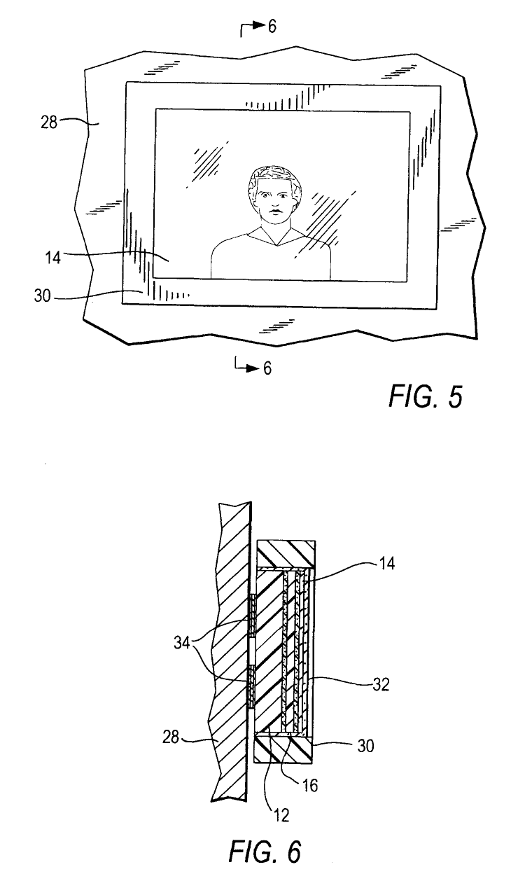

In FIGS. 5-6, the resilient foam panel 12 lies in the aforementioned flat configuration and the aforementioned sheet article 14 is adhered in surface area contact to the adhesive carrier 16 on the foam panel 12, and a frame 30 consisting of a resilient foam material peripherally surrounds the foam panel 12 with a snug, compression fit. The foam frame 30 bounds an opening sized slightly smaller than the size of the foam panel 12 to insure a snug, tight, resiliently elastic engagement between the foam panel 12 and the frame 30. The foam frame 30 and the foam panel 12 may have any shape, but each is preferably rectangular. The foam frame 30 may be formed as a single die-cut piece, or as a plurality of pieces, e.g., four frame pieces arranged as sides of a rectangle. An optional light-transmissive cover 32 (see FIG. 6) advantageously overlies the foam panel 12 and the sheet article 14 and is surrounded by the frame 30.

Adhesive carriers, such as one or more strips 34, could be pre-attached on the foam panel 12 (FIG. 6) and/or the frame 30 (FIG. 8), or can be attached when needed, for repositionably adhering the foam panel 12 and/or the frame 30 to a generally upright support surface, such as a wall 28 shown in FIGS. 5-6, without marring or puncturing the wall 28. Advantageously, an adhesive strip 34 is provided for each frame piece. The strips 34 occupy less than the entire surface area of the foam panel 12 and/or the frame 30, thereby aiding in removal of the display device from the wall 28, and also allowing for use of a stronger repositionable adhesive than in full coverage. Each strip 34 is preferably linear and has peripheral edges parallel to a peripheral edge of the foam panel 12. If two strips 34 are employed, then they are preferably parallel to each other.

Each adhesive strip 34 comprises a central substrate having its side facing the foam panel 12 coated with a permanent, pressure-sensitive adhesive, such as a rubber- or acrylic-based adhesive, and its opposite side facing the wall 28 coated with a repositionable, pressure-sensitive adhesive that allows multiple opportunities and time, for example, one hour, to accurately position the foam panel 12 on the wall 28. The repositionable adhesive leaves no residue or puncture marks on the surface to which it is adhered. Advantageously, a removable protective release liner covers the repositionable adhesive. The release liner is removed just before the foam panel 12 is adhered to the wall 28. The resilience and flexibility of the foam panel 12 and/or the frame 30 enable the foam panel 12 and/or the frame 30 to readily self-conform to, and self-compensate for, any non-planar irregularities commonly encountered on the wall 28. Double-sided foam tape is not needed, as in the prior art, for such direct wall mounting.

The foam frame 30 and foam panel 12 are an attractive assembly, well suited for mounting in a nursery where hard, rigid framing structures are to be avoided in the interest of child safety. Alternatively, the aforementioned support 24 can be used to support the foam frame 30 and foam panel 12 on the aforementioned support surface 18.

One or more of the resilient foam panels 12 in various sizes and shapes can be provided in craft kit form. The kit may also advantageously include one or more of the foam frames 30 in various sizes and shapes, as well as one or more of the aforementioned supports 24 and covers 32. Adhesive strips 34 may be provided in advance on a rear surface of each foam panel 12 or frame 30, or the adhesive strips may be provided for subsequent attachment by the consumer. Preferably, each foam panel 12 is covered in advance with the adhesive carrier 16, but it is also contemplated that the consumer may wish to subsequently coat the front surface of each foam panel 12 with a supplied adhesive. The sheet article 14 may be mounted in advance on the foam panel 12 by a retailer, or subsequently by the consumer. The frame 30 surrounding the mounted foam panel 12 is easily removed therefrom and interchanged with another frame from the kit.

Many consumer and professional processors of photographic prints are presently using a dye-sublimation, heat transfer process for printing digital photographs at self-service kiosks. Unlike traditional chemical printing processes, the dye-sublimation process produces photographs that are completely waterproof. Utilizing the foam frames 30 and the foam panels 12, in conjunction with the dye-sublimation printed photographs, results in a completely waterproof system for displaying photographs in such wet environments as outdoor displays, bathrooms, and shower stalls, thereby increasing the versatility of this invention.

It will be understood that each of the elements described above, or two or more together, also may find a useful application in other types of constructions differing from the types described above. For example, rather than using the aforementioned adhesive strips, magnetic strips can be substituted and used to hold the foam panel 12 to a support surface, e.g., a metallic surface, to which the magnetic strips are attracted by magnetic action. In the event that the wall 28 is covered with a fabric, such as in an office cubicle partition, then rather than using the aforementioned adhesive strips, hook-type fasteners sold under the trademark Velcro can be substituted and used to hold the foam panel 12 to a loop-type fabric wall.

While the invention has been illustrated and described as embodied in display devices for holding and displaying sheet articles, it is not intended to be limited to the details shown, since various modifications and structural changes may be made without departing in any way from the spirit of the present invention. For example, the sheet article can be in a landscape or a portrait orientation.

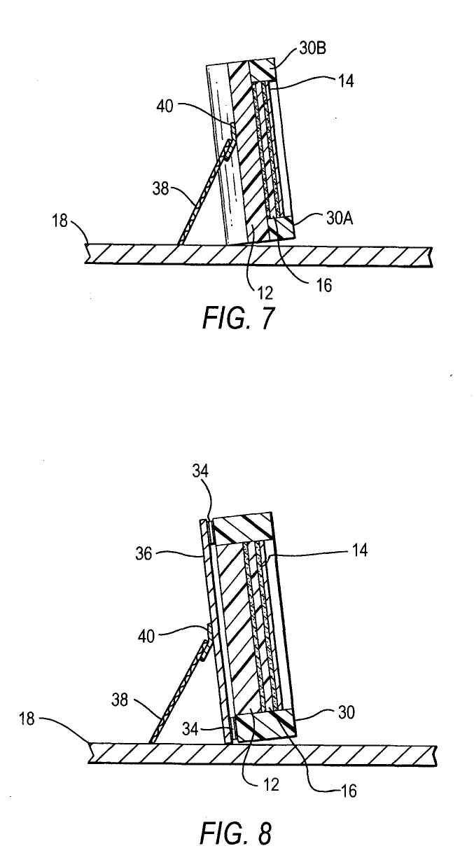

As another example, in a variant construction, as shown in FIG. 7, the foam frame 30, which includes lower frame piece 30A and upper frame piece 30B, need not hold the foam panel 12 with a snug, compression fit, but could be adhered to the foam panel 12. More specifically, in this variant construction, the aforementioned sheet article 14 is adhered in surface area contact on the foam panel 12. Preferably, the foam panel 12 has length and width dimensions that are greater than those of the sheet article 14. The foam frame 30 has length and width external dimensions that match those of the foam panel 12 and bounds an interior opening sized to be either equal to, or greater, than the size of the sheet article 14. The foam frame 30 is adhered, preferably with a repositionable adhesive, to the foam panel 12 such that the sheet article 14 is visible through the opening. The foam frame 30 can be made of one piece, or of a plurality of frame pieces. The assembly of the foam frame 30 and the foam panel 12 can be bent from a generally planar configuration to an arcuate configuration any desired number of times, and the non-stretchable base sheet of the sheet article holds and maintains the assembly in the arcuate configuration, thereby enabling viewing of the framed image in curved form. A rear brace 38 is hinged to the foam panel 12 by a hinge 40. The brace 38 may be constituted of a rigid material, such as corrugated board. The hinge 40 may be constituted of a thin flexible film material, such as aluminum. The hinge 40 may be folded up as shown, or folded down, or otherwise configured. The brace 38 supports the display device on the horizontal support surface 18.

FIG. 8 depicts another example of a front-loading display device similar to that shown in FIGS. 6-7, except that the strips 34 are attached directly to a backing board 36 that, in turn, is supported on the horizontal support surface 18 by the rear brace 38 that is hinged to the board 36 by the hinge 40. The board 36 may be constituted of a foam material. The brace 38 and the hinge 40 may be removed from the board 36 if so desired, and then mounted on the wall 28 with the aid of additional strips 34. The front-loading display devices of FIGS. 6-8 enable quick and easy loading of the sheet articles from the front of the device and contrasts with the more laborious rear-loading display devices of the prior art.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

As another example, the foam panel 12 in FIGS. 6-8 need not be constituted of a resilient foam, but could be constituted as a stiff, laminated foam board of the type consisting of an inner layer of polystyrene foam and a pair of outer cladding pulp-based layers. The sheet article 14 is adhered in surface area contact with the stiff board, and then, the resilient foam frame 30 in FIGS. 6 and 8 peripherally surrounds and holds the stiff board with a snug, compression fit.

What is claimed as new and desired to be protected by Letters Patent is set forth in the appended claims.

I claim:

1. A display device, comprising:
a foam panel resiliently bendable from a generally planar configuration to an arcuate configuration; and
a sheet article including a base sheet bearing an image to be displayed, and adhered in surface area contact to the foam panel, the base sheet being non-stretchable to hold and maintain the foam panel in the arcuate configuration, thereby enabling viewing of the image in curved form.

2. The display device of claim 1, and a planar, double-sided adhesive carrier between the foam panel and the base sheet, for adhering the base sheet over its entire surface area to the foam panel.

3. The display device of claim 1, wherein the foam panel has a thickness on the order of from 2 mm to 10 mm, and is entirely constituted of a flexible, water-resistant, non-laminated, foam material.

4. The display device of claim 1, and a frame surrounding the sheet article and having an opening in which the image is visible.

5. The display device of claim 1, wherein the foam panel has a generally planar bottom edge for contacting a generally planar support surface, and wherein the foam panel in the arcuate configuration enables the display device to be self-standing on the generally planar support surface.

6. The display device of claim 1, and a deformable support on the foam panel and having a deformed portion for supporting the sheet article.

7. A display device, comprising:
a foam panel lying in a generally planar configuration;
a sheet article including a base sheet bearing an image to be displayed, and adhered in surface area contact to the foam panel; and
a resilient frame consisting of a foam material and having an opening peripherally surrounding the image.

8. The display device of claim 7, wherein the frame peripherally surrounds and holds the foam panel with a compression fit.

9. The display device of claim 7, wherein the frame rests on the foam panel.

10. The display device of claim 7, and a backing board on which the foam panel is mounted.

11. The display device of claim 7, and an adhesive carrier for repositionably adhering at least one of the foam panel and the frame to a generally upright support surface, and wherein the at least one of the foam panel and the frame is flexible and self-conforms to any irregularities on the generally upright support surface.

12. The display device of claim 7, wherein the frame is interchangeably mounted on the foam panel.

13. A display device component, comprising:
a flexible foam panel self-conformable to irregularities on a generally upright support surface, the foam panel having a pair of opposite surfaces;
a first, repositionable, pressure-sensitive adhesive entirely occupying one of the surfaces of the foam panel; and
a second, repositionable, pressure-sensitive adhesive partially occupying the other of the surfaces of the foam panel, for repositionably and directly adhering the foam panel to the generally upright support surface.

14. The display device component of claim 13, and a sheet article including a base sheet bearing an image to be displayed, and adhered to the one surface of the foam panel.

15. The display device component of claim 13, wherein the second adhesive extends along at least one strip on the other surface of the foam panel.

16. The display device component of claim 14, wherein the sheet article has a peripheral linear edge, and wherein the second adhesive extends along at least one strip on the other surface of the foam panel, and wherein the at least one strip has a peripheral linear edge extending generally parallel to the peripheral edge of the sheet article.

17. A display method, comprising the steps of:
bending a resilient foam panel from a generally planar configuration to an arcuate configuration; and
holding and maintaining the foam panel in the arcuate configuration by adhering a non-stretchable base sheet of a sheet article bearing an image to be displayed, in surface area contact to the foam panel, thereby enabling viewing of the image in curved form.

18. The method of claim 17, and performing the bending step more than once to adjust the arcuate configuration, and wherein the adhering step holds and maintains the foam panel in the arcuate configuration to which the foam panel has been adjusted.

19. The method of claim 17, wherein the adhering step is performed by repositionably adhering the base sheet to the foam panel.

20. The method of claim 17, and repositionably adhering the foam panel to a generally upright support surface.
